(19) United States
(12) Patent Application Publication
(10) Pub. No.: US 2017/0198405 A1
(43) Pub. Date: Jul. 13, 2017

(54) Zero polar distance ion exchange membrane and preparation method thereof

(71) Applicant: SHANDONG DONGYUE POLYMER MATERIAL CO., LTD., Zibo,Shandong (CN)

(72) Inventors: Jing Wang, Zibo (CN); Yongming Zhang, Zibo (CN); Miaokun Yang, Zibo (CN); Heng Zhang, Zibo (CN)

(21) Appl. No.: 15/314,929

(22) PCT Filed: Jul. 7, 2014
(86) PCT No.: PCT/CN2014/000654

§ 371 Date: Nov. 29, 2016

(30) Foreign Application Priority Data
Jun. 6, 2014 (CN) 201410249917.5

(51) Int. Cl. C25B 13/08; B01D 71/66; B01D 67/00; B01D 69/02; C25B 13/02; C25B 1/46

(52) U.S. Cl. CPC C25B 13/08; C25B 13/02; C25B 1/46; B01D 67/0013; B01D 69/02; B01D 71/66; B01D 2323/46; B01D 2325/42

(57) ABSTRACT

A zero polar distance ion exchange membrane. A polymer membrane is compositely prepared by a perfluorinated ion exchange resin and a reinforcing material, and the polymer membrane is converted into an ion exchange membrane. A non-electrode porous gas release layer is adhered to at least one side of the ion exchange membrane. The non-electrode porous gas release layer is formed by drying after adhering a dispersion liquid to an ion exchange membrane layer surface. The dispersion liquid is formed by dispersing perfluorinated sulphonic acid resin broken micro-particles in a sulphonic acid resin aqueous alcohol solution. The prepared zero polar distance ion exchange membrane is used in the chlor-alkali industry, stably and effectively treats an alkali metal chloride solution having a high impurity content, is able to better suited for operating in a zero polar distance electrolysis cell under high current density conditions, and has a very low surface resistance. Also provided is a preparation method for the zero polar distance ion exchange membrane. The preparation method has a simple and reasonable process, and facilitates industrial production.

### CROSS REFERENCE OF RELATED APPLICATION

This is a U.S. National Stage under 35 U.S.C 371 of the International Application PCT/CN2014/000654, filed Jul. 07, 2014, which claims priority under 35 U.S.C. 119(a-d) to CN 201410249917.5, filed Jun. 6, 2014.

### BACKGROUND OF THE PRESENT INVENTION

Field of Invention

The present invention relates to a technical field of ionic membranes, and more particularly to a zero polar distance ion exchange membrane and a preparation method thereof.

Description of Related Arts

In recent years, during the ion-exchange membrane chlor-alkali production, in order to achieve electrolysis under high current density, low cell voltage and high lye concentration for improving productivity and reducing power consumption, the key is to shorten the distance between the ion-exchange membrane and the electrode for reducing the cell voltage thereof, thereby achieving the practicality of the narrow polar distance type ion-exchange membrane electrolysis process. With the continuous progress of technology, the zero polar distance electrolytic cell has been widely applied, and however, when the distance between the electrodes is reduced to be less than 2 mm, due to tightly attachment between the membrane and the negative electrode, hydrogen bubbles attached to the membrane surface are hard to be released, thus a large amount of hydrogen bubbles are accumulated on the membrane surface which faces to the negative electrode. The bubbles blocks the current channel for reducing the effective electrolytic area of the membrane, which results in unevenly current distribution on the membrane surface, thus the local polarization is obviously increased. Therefore, the membrane resistance and the cell voltage are sharply increased, and the electrolysis power consumption is significantly improved.

To overcome the shortcomings caused by the bubble effect, and rapidly release the attached hydrogen bubbles from the membrane surface with small hydrophilicity, a modification method of a hydrophilic coating on the ion-exchange membrane surface is developed. After coating a multi-porous non-electrocatalytic activity non-electrode coating, through which gases and liquids are able to permeate, on the membrane surface, the hydrophilicity of the membrane surface is obviously increased, the anti-foaming ability are significantly improved. The ion exchange membrane with the modified hydrophilic coating is able to be tightly attached to the electrode, so as to greatly reduce the cell voltage. Currently, it is widely applied to the zero polar distance type ion exchange membrane electrolysis process. The hydrophilic coating modification process includes steps of mixing inorganic components with special adhesives, and then coating on the ion exchange membrane surface through an electrolytic deposition method or a particle embedding method. Patent applications CA2446448 and CA2444585 specifically introduced the coating process. However, the above modification method has significant effect, but relatively complex process. Moreover, during the electrolysis operation, because the ion exchange membrane is continuously scoured by the lye flow and goes through the continuous shock caused by the turbulence, the hydrophilic coating attached to the ion exchange membrane surface gradually falls off, thus the anti-foaming function is gradually reduced to be of no effect.

Patent application U.S. Pat. No. 4,502,931 proposed to process the ion exchange membrane surface with surface roughening modification through an ion etching method. However, the method is not easy to be implemented on a large scale, and has low anti-foaming ability. When the distance between electrodes is reduced to a certain degree, the cell voltage is still larger than 3.5 V, and the current efficiency is lower than 90%.

Therefore, it is very important to develop a long-term effective ion exchange membrane surface processing method; during the zero polar distance electrolysis process, the ion exchange membrane is able to continuously provide excellent anti-foaming effect, reduce the cell voltage, improve the current efficiency and reduce the power consumption.

### SUMMARY OF THE PRESENT INVENTION

In view of deficiencies in the prior art, an object of the present invention is to provide a zero polar distance ion exchange membrane, which is adapted for chlor-alkali industry, so as to stably and highly-effective process the alkali metal chloride solution with higher impurity content, is more suitable for operating in a zero polar distance electrolytic cell under a condition of high current density, and has a very low surface resistance. Furthermore, the present invention also provides a preparation method of the zero polar distance ion exchange membrane, which facilitates the industrial production.

The zero polar distance ion exchange membrane, provided by the present invention, is a polymer membrane compositely prepared by perfluorinated ion exchange resin and a reinforcement material, wherein: the polymer membrane is converted to the ion exchange membrane, a non-electrode multi-porous gas release layer is attached to at least one side of the ion exchange membrane; the non-electrode multi-porous gas release layer is formed by drying after adhering a dispersion liquid to the ion exchange membrane surface; the dispersion liquid is formed by dispersing perfluorosulfonic acid resin broken micro-particles in a sulfonic acid resin water alcohol solution.

In which:

The perfluorosulfonic acid resin broken micro-particles are formed by converting perfluorosulfonic acid resin in NaOH solution to sodium-type, and then grinding through a nano grinding machine, and finally obtaining the broken micro-particles with irregular polyhedron morphology, wherein: the nano grinding machine is a nano grinding machine with deep cooling; during the grinding process, a strong shearing force applied to the resin particles allows the broken micro-particles to have the irregular polyhedron morphology; the micro-particles with the irregular polyhedron morphology are not easy to be reunited and has uniform particle size and good dispersion effect. The perfluorosulfonic acid resin broken micro-particles has the ion exchange function.

The reinforcement material is one of a mesh material, a fibrous material, a nonwoven fabric material and a porous membrane material which are made of any one of polytetrafluoroethylene (PTFE), polyperfluoroalkoxy resin (PFA), poly ethylene propylene (FEP), and ethylene-tetrafluoroethylene copolymer (ETFE). It is adapted for improving the mechanical strength and prepared by the prior art.

A surface hydrophilic contact angle of the ion exchange membrane attached with the non-electrode multi-porous gas release layer is smaller than 90°, and a surface resistance of the ion exchange membrane is lower than 1.2 Ω·cm⁻².

An ion exchange capability of the perfluorosulfonic acid resin broken micro-particles is in a range of 0.4-0.9 mmol/g; and preferably, 0.5-0.7 mmol/g. When the ion exchange capability is too high, the perfluorosulfonic acid resin broken micro-particles in the water alcohol solution have a certain swelling degree, so that the own irregular morphology of the broken particles are destroyed; and a volume of the broken particles is expanded, such that a porosity is seriously reduced and ion channels are blocked; the broken particles are not easily broken.

A particle size of the perfluorosulfonic acid resin broken micro-particles is in a range of 0.05-20 μm; and preferably, 0.1-8 μm. When the particle size is too low, the particles are easily reunited to block the ion channels; when the particle size is too high, the micro-particles formed on the membrane surface obviously protrudes from the membrane surface, so that they are easy to be detached from the membrane surface under external scratches.

The perfluorosulfonic acid resin broken micro-particles are dispersed in the sulfonic acid resin water alcohol solution to form the dispersion liquid, so as to obviously improve the surface hydrophilicity and the desorption function to produced gases of the ion exchange membrane.

In the dispersion liquid, a content of the perfluorosulfonic acid resin broken micro-particles by weight is 5-40%, and preferably, 8-20%.

In the sulfonic acid resin water alcohol solution, a content of the sulfonic acid resin by weight is 0.05-20%, and preferably, 0.5-10%. The study found that if the content of the sulfonic acid resin is too high, then the dispersion liquid has high viscosity, which goes against manufacturing the multi-porous coating. Furthermore, the sulfonic acid resin water alcohol solution with too high viscosity will affect the dispersion effect of the perfluorosulfonic acid resin broken micro-particles therein, so that the gas release effect is reduced. In addition, too high viscosity will result in a decrease of the porosity of the gas release layer, thereby affecting an operation effect of the membrane under the high current density.

The dispersion liquid is sprayed onto the ion exchange membrane surface, and then is dried, a distribution quantity of the perfluorosulfonic acid resin broken micro-particles on the polymer membrane surface is 0.01-15 mg/cm², and preferably, 0.05-8 mg/cm². The present invention found that if the distribution quantity of the particles is too small, the gas release effect is reduced.

The surface hydrophilic contact angle of the ion exchange membrane attached with the non-electrode multi-porous gas release layer is smaller than 90°, the smaller the contact angle, the better the hydrophilicity and the easier desorption of the surface gas. The surface resistance of the ion exchange membrane is lower than 1.2 Ω·cm⁻².

A proportion of water and alcohol in the sulfonic acid resin water alcohol solution is selected according to the prior art, the alcohol is preferably methanol, ethanol, propanol, ethylene glycol or isopropanol. Preferably, the proportion of the water and the alcohol is 1:1.

The non-electrode multi-porous gas release layer on the ion exchange membrane surface is formed by multiple kinds of processes. A conventional surface coating preparation method comprises spray coating, brush coating, roll coating, dipping, transferring and spin coating; and preferably, is spray coating and roll coating. The process is processed according to the prior art.

The non-electrode multi-porous gas release layer has a width within a range of 0.1-30 nm, is able to be only attached to a single side of the ion exchange membrane, and be synchronously attached to two sides of the ion exchange membrane. The ion exchange membrane, provided by the present invention is used to be a separation membrane in an alkaline electrolysis cell, wherein: one side of the ion exchange membrane attached with the non-electrode multi-porous gas release layer is preferably installed at a cathode side of the electrolysis cell, for stably and highly-effectively processing the alkali metal chloride solution with high impurity content.

The non-electrode multi-porous gas release layer is a non-continuous multi-porous layer, has a porosity of 35-99%, and preferably, 60-95%; the non-electrode multi-porous gas release layer is a discontinuous multi-porous structure formed by the sulfonic acid resin in the water alcohol solution encasing the perfluorosulfonic acid resin broken micro-particles in a discontinuous state. The non-electrode multi-porous gas release layer is too low in porosity, which results in an increase of the cell pressure.

The polymer membrane is compositely prepared by a perfluorinated ion exchange resin and a reinforcing material. The perfluorinated ion exchange resin is a single-layer membrane or a composite membrane, which is prepared by one or multiple kinds of perfluorinated ion exchange resin containing one or two functional groups in sulfonic acid or carboxylic acid, through a single or multi-machine co-extrusion method. It is able to be sulfonic acid single layer membrane, sulfonic acid carboxylic acid mixing single layer membrane, sulfonic acid/sulfonic acid composite membrane, sulfonic acid/carboxylic acid composite membrane, sulfonic acid/sulfonic acid carboxylic acid copolymer/carboxylic composite membrane, sulfonic acid/sulfonic acid carboxylic acid mixture/carboxylic composite membrane. Preparation methods of all polymer membranes are based on the prior art.

A preparation method of the zero polar distance ion exchange membrane, provided by the present invention, comprises steps of:

(1) through a screw extruder, in a co-extrusion manner, melting and casting perfluorinated ion exchange resin to a single layer membrane or a multi-layer composite membrane, and simultaneously, introducing a reinforcement material between two membrane forming rollers, pressing the reinforcement material into a membrane body under an action of a pressure between the rollers, and forming a polymer membrane;

(2) immersing the polymer membrane in the step (1) to a mixed aqueous solution of dimethyl sulfoxide and NaOH, and converting the polymer membrane into an ion exchange membrane with ion exchange function;

(3) dissolving perfluorosulfonic acid resin, putting the dissolved perfluorosulfonic acid resin into a water alcohol mixture, forming sulfonic acid resin water alcohol solution, adding perfluorosulfonic acid resin broken micro-particles, homogenizing in a ball mill, and forming a dispersion liquid; and

(4) through surface coating, adhering the dispersion liquid to the ion exchange membrane surface obtained in the step (2), forming a discontinuous multi-porous gas release layer after drying, and obtaining a product.

Wherein, in the step (1), the perfluorinated ion exchange resin is one or more, one or more screw extruders are adopted, and an extrusion manner is a single layer or multi-layer co-extrusion manner.

In the step (2), preferably, a content of dimethyl sulfoxide in the mixed aqueous solution by weight is 15 wt % and a content of NaOH in the mixed aqueous solution by weight is 20 wt %.

The non-electrode multi-porous gas release layer on the ion exchange membrane surface is formed by multiple kinds of processes. The surface coating preparation method in the step (4) comprises spray coating, brush coating, roll coating, dipping, transferring and spin coating; and preferably, is spray coating and roll coating. The process is processed according to the prior art.

The zero polar distance ion exchange membrane, prepared by the above method, for chlor-alkali industry is able to stably and highly-effectively process the alkali metal chloride solution with high impurity content, is better adopted for operating in a zero polar distance electrolysis cell under the condition of high current density, and has a very low surface resistance.

In conclusion, the present invention has advantages as follows.

(1) The perfluorosulfonic acid resin broken micro-particles have the ion exchange function, are attached to the ion exchange membrane surface and no block is formed, so that the present invention is very adapted for being operated under high current density.

(2) The surface hydrophilic contact angle of the ion exchange membrane attached with the non-electrode multi-porous gas release layer is smaller than 90°. The excellent hydrophilicity of the present invention effectively reduces the accumulation of the bubbles on the membrane surface, thereby significantly reducing the surface resistance and the cell voltage.

(3) The perfluorosulfonic acid resin broken micro-particles has excellent compatibility with the ion exchange membrane, and are not easy to be detached from each other. During the whole service life time of the membrane, the function which suppresses the generation of bubbles is not attenuated with the extension of time.

(4) The zero polar distance ion exchange membrane prepared by the present invention in the zero polar distance electrolytic cell is able to achieve the following technical indicators: under the condition that the current density is 6 kA/m² or even higher, the surface resistance ≦1.2 Ω·cm⁻², the average cell voltage ≦2.85 V, the average current efficiency ≧98.5%, and the tested wear loss of the ion exchange membrane ≦5 mg using the ASTM Standard D 1044-99.

(5) In the zero polar distance electrolysis process, the zero polar distance ion exchange membrane prepared by the present invention is able to continuously provide good anti-foaming effect, reduce the cell voltage, improve the current efficiency and reduce the power consumption.

### DETAILED DESCRIPTION OF THE PREFERRED EMBODIMENT

The present invention is further explained with accompanying embodiments in detail.

Concentrations in the examples are by mass unless otherwise specified.

A polymer membrane described in the examples is made of perfluorinated ion exchange resin with a structure as follows, wherein: a repetitive unit of sulfonic acid resin is

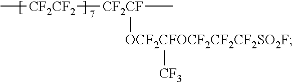

a repetitive unit of carboxylic acid resin is

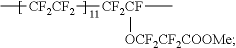

a repetitive unit of sulfonic acid carboxylic acid polymer is

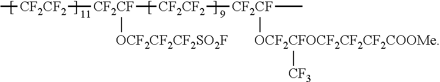

### Example 1

A preparation method of a zero polar distance ion exchange membrane comprises steps of:

(1) processing perfluorosulfonic acid resin with IEC=1.4 mmol/g, perfluorosulfonic acid carboxylic acid copolymer resin with IEC=1.0 mmol/g and perfluorocarboxylic acid resin with IEC=0.95 mmol/g, with a mass fraction ratio of 100:5:10 in a co-extrusion and cast manner, forming a composite membrane with a total thickness of 135 μm; and simultaneously, introducing a PTFE (polytetrafluoroethylene) mesh fabric between two membrane forming rollers, the PTFE mesh fabric entering a membrane body through rolling compounding, and forming a polymer membrane;

(2) immersing the polymer membrane in the step (1) to a mixed aqueous solution of dimethyl sulfoxide with a weight percentage of 15 wt % and NaOH with a weight percentage of 20 wt % for 80 minutes at 85° C., and then converting the polymer membrane into an ion exchange membrane with ion exchange function;

(3) preparing a water alcohol mixture by mixing water and alcohol with a weight ratio of 1:1, dissolving perfluorosulfonic acid resin with IEC=0.9 mmol/g, putting the dissolved perfluorosulfonic acid resin into the water alcohol mixture, forming sulfonic acid resin solution with a concentration of 2 wt %, adding perfluorosulfonic acid resin broken micro-particles with IEC=0.78 mmol/g, an average particle size of 0.5 pm and irregular polyhedron morphology to the sulfonic acid resin solution, homogenizing in a ball mill, and forming a dispersion liquid with a content of 15 wt %; and

(4) through spraying, adhering the dispersion liquid to surfaces at two sides of the ion exchange membrane surface obtained in the step (2), and forming a discontinuous multi-porous gas release layer with a porosity of 86% after drying, wherein: a distribution quantity of the perfluorosulfonic acid resin broken micro-particles on the composite membrane surface is 4.6 mg/cm², a hydrophilicity of the membrane is tested by a contact angle measuring instrument, and a contact angle is 77°.

### Performance Testing

An electrolytic test of the prepared ion exchange membrane about NaCl aqueous solution in an electrolysis cell is performed. 300 g/L NaCl aqueous solution is supplied to an anode chamber, water is supplied to a cathode chamber, it is ensured that a concentration of NaCl discharged from the anode chamber is 200 g/L, and a concentration of NaOH discharged from the cathode chamber is 32%; a test temperature is 90° C., a current density is 8 kA/m²; after 23 days of electrolysis experiments, the average cell voltage is 2.73 V and the average current efficiency is 99.1%.

Afterwards, based on standard SJ/T 10171.5, a surface resistance of the obtained membrane is tested to be 1.0 Ω·cm⁻²; based on ASTM Standard D 1044-99, a wear loss of the obtained membrane is tested to be 2.6 mg.

### Comparative Example 1

A same method as the example 1 is adopted to prepare the ion exchange membrane with ion exchange function; afterwards, a same method is adopted to prepare the dispersion liquid. Differences between the example 1 and the comparative example 1 are as follows. The perfluorosulfonic acid resin broken micro-particles in the dispersion liquid are replaced by zirconium oxide particles with an average particle size of 0.5 μm, and then homogenized in the ball mill, and the dispersion liquid with a content of 15 wt % is formed. The same method is adopted to obtain the ion exchange membrane attached with the discontinuous multi-porous gas release layer at two sides thereof. The distribution quantity of the zirconium oxide particles on the composite membrane surface is also 4.6 mg/cm², the porosity of the membrane is reduced to 73%; the hydrophilicity thereof is tested by the contact angle measuring instrument, and the contact angle is 126°.

Under the same conditions as the example 1, the electrolytic test of NaCl aqueous solution is performed. After 23 days of electrolysis experiments, the average cell voltage is 2.98 V, the average current efficiency is 96.0%, the surface resistance is 2.3 Ω·cm⁻², and the wear loss is 7.4 mg.

### Example 2

A same method as the example 1 is adopted to prepare an ion exchange membrane with ion exchange function. Afterwards, a water alcohol mixture is prepared by mixing water and alcohol with a weight ratio of 1:1, perfluorosulfonic acid resin with IEC=0.9 mmol/g is dissolved, the dissolved perfluorosulfonic acid resin is put into the water alcohol mixture, sulfonic acid resin solution with a concentration of 6 wt % is formed; and then perfluorosulfonic acid resin broken micro-particles with IEC=0.45 mmol/g, an average particle size of 0.05 μm and irregular polyhedron morphology are added to the sulfonic acid resin solution and are homogenized in a ball mill, and a dispersion liquid with a content of 9 wt % is formed.

Through spraying, the dispersion liquid is adhered to surfaces at two sides of the above ion exchange membrane surface, and a discontinuous multi-porous gas release layer with a porosity of 91% is formed after drying, wherein: a distribution quantity of the perfluorosulfonic acid resin broken micro-particles on the composite membrane surface is 5.2 mg/cm², a hydrophilicity of the membrane is tested by a contact angle measuring instrument, and a contact angle is 81°.

An electrolytic test of the prepared ion exchange membrane about NaCl aqueous solution in an electrolysis cell described in Example 1 is performed; a current density is 10 KA/m²; after 17 days of electrolysis experiments, an average cell voltage is 2.79 V, and an average current efficiency is 99.0%.

Afterwards, based on standard SJ/T 10171.5, a surface resistance of the obtained membrane is tested to be 0.90 Ω·cm⁻²; based on ASTM Standard D 1044-99, a wear loss of the obtained membrane is tested to be 3.1 mg.

### Example 3

A same method as the example 1 is adopted to prepare an ion exchange membrane with ion exchange function. Afterwards, a water alcohol mixture is prepared by mixing water and propanol with a weight ratio of 1:1, perfluorosulfonic acid resin with IEC=0.9 mmol/g is dissolved, the dissolved perfluorosulfonic acid resin is put into the water alcohol mixture, sulfonic acid resin solution with a concentration of 1 wt % is formed; and then perfluorosulfonic acid resin broken micro-particles with IEC=0.75 mmol/g, an average particle size of 5 μm and irregular polyhedron morphology are added to the sulfonic acid resin solution and are homogenized in a ball mill, and a dispersion liquid with a content of 4.6 wt % is formed.

Through spraying, the dispersion liquid is adhered to surfaces at two sides of the above ion exchange membrane surface, and a discontinuous multi-porous gas release layer with a porosity of 94% is formed after drying, wherein: a distribution quantity of the perfluorosulfonic acid resin broken micro-particles on the composite membrane surface is 6.8 mg/cm², a hydrophilicity of the membrane is tested by a contact angle measuring instrument, and a contact angle is 68°.

An electrolytic test of the prepared ion exchange membrane about NaCl aqueous solution in an electrolysis cell described in Example 1 is performed; a current density is 12 KA/m²; after 23 days of electrolysis experiments, an average cell voltage is 2.83 V, and an average current efficiency is 99.0%.

Afterwards, based on standard SJ/T 10171.5, a surface resistance of the obtained membrane is tested to be 0.95 Ω·cm⁻²; based on ASTM Standard D 1044-99, a wear loss of the obtained membrane is tested to be 2.1 mg.

Afterwards, 10 ppm organic matter n-chlorododecyl trimethyl ammonium chloride is added to the NaCl aqueous solution. Under the same conditions as the above description, after 40 days of electrolysis experiments, an average cell voltage is 2.85 V, and an average current efficiency is 99.0%.

### Example 4

Differences between the example 4 and the example 3 are as follows. In the example 4, the prepared dispersion liquid is coated to one side of the ion exchange membrane with ion exchange function mentioned in the example 3 in a brush coating manner, and the side is installed to a cathode side of an electrolytic cell; after drying, a discontinuous multi-porous gas release layer with a porosity of 94% is formed; a distribution quantity of the perfluorosulfonic acid resin broken micro-particles on the composite membrane surface is 3.4 mg/cm², a hydrophilicity of the membrane is tested by a contact angle measuring instrument, and a contact angle is 68°.

An electrolytic test of the prepared ion exchange membrane about NaCl aqueous solution in an electrolysis cell described in Example 1 is performed; a current density is 12 KA/m²; after 23 days of electrolysis experiments, an average cell voltage is 2.85 V, and an average current efficiency is 98.6%.

Afterwards, based on standard SJ/T 10171.5, a surface resistance of the obtained membrane is tested to be 1.2 Ω·cm⁻²; based on ASTM Standard D 1044-99, a wear loss of the obtained membrane is tested to be 2.1 mg.

### Example 5

Differences between the example 5 and the example 3 are as follows. In the example 5, the prepared dispersion liquid is coated to one side of the ion exchange membrane with ion exchange function mentioned in the example 3 in a brush coating manner, and the side is installed to an anode side of an electrolytic cell; after drying, a discontinuous multi-porous gas release layer with a porosity of 94% is formed; a distribution quantity of the perfluorosulfonic acid resin broken micro-particles on the composite membrane surface is 3.4 mg/cm², a hydrophilicity of the membrane is tested by a contact angle measuring instrument, and a contact angle is 68°.

An electrolytic test of the prepared ion exchange membrane about NaCl aqueous solution in an electrolysis cell described in Example 1 is performed; a current density is 12 KA/m²; after 23 days of electrolysis experiments, an average cell voltage is 3.07 V, and an average current efficiency is 96.6%.

Afterwards, based on standard SJ/T 10171.5, a surface resistance of the obtained membrane is tested to be 2.7 Ω·cm⁻²; based on ASTM Standard D 1044-99, a wear loss of the obtained membrane is tested to be 2.1 mg.

### Example 6

(1) processing perfluorosulfonic acid resin with IEC=1.2 mmol/g, and a blending resin forming by mixing perfluorosulfonic acid with IEC=1.3 mmol/g and perfluorocarboxylic acid with IEC=0.89mmol/g in a proportion of 1:1, with a mass fraction ratio of 100:9 in a co-extrusion and cast manner, forming a composite membrane with a total thickness of 120 μm; and simultaneously, introducing a PFA non-woven fabric between two membrane forming rollers, the PFA non-woven fabric entering a membrane body through rolling compounding, and forming a polymer membrane;

(2) immersing the polymer membrane in the step (1) to a mixed aqueous solution of dimethyl sulfoxide with a weight percentage of 15 wt % and NaOH with a weight percentage of 20 wt % for 80 minutes at 85° C., and then converting the polymer membrane into an ion exchange membrane with ion exchange function;

(3) preparing a water alcohol mixture by mixing water and isopropanol with a weight ratio of 2:1, dissolving perfluorosulfonic acid resin with IEC=0.95 mmol/g, putting the dissolved perfluorosulfonic acid resin into the water alcohol mixture, forming sulfonic acid resin solution with a concentration of 0.05 wt %, adding perfluorosulfonic acid resin broken micro-particles with IEC=0.9 mmol/g, an average particle size of 10 um and irregular polyhedron morphology to the sulfonic acid resin solution, homogenizing in a ball mill, and forming a dispersion liquid with a content of 40 wt %; and

(4) through brush coating, adhering the dispersion liquid to surfaces at two sides of the ion exchange membrane surface obtained in the step (2), and forming a discontinuous multi-porous gas release layer with a porosity of 99% after drying, wherein: a distribution quantity of the perfluorosulfonic acid resin broken micro-particles on the composite membrane surface is 0.6 mg/cm², a hydrophilicity of the membrane is tested by a contact angle measuring instrument, and a contact angle is 74°.

An electrolytic test of the prepared ion exchange membrane about NaCl aqueous solution in an electrolysis cell described in Example 1 is performed; a current density is 8 KA/m²; after 43 days of electrolysis experiments, an average cell voltage is 2.71 V, and an average current efficiency is 99.2%.

Afterwards, based on standard SJ/T 10171.5, a surface resistance of the obtained membrane is tested to be 1.0 Ω·cm⁻²; based on ASTM Standard D 1044-99, a wear loss of the obtained membrane is tested to be 2.9 mg.

### Example 7

The substrate membrane prepared in the embodiment 6 is enhanced by adopting FEP multi-porous membrane to form a polymer membrane; and then is converted into an ion exchange membrane under same conversion conditions.

Afterwards, a water alcohol mixture is prepared by mixing water and ethanol with a weight ratio of 1:1.2, perfluorosulfonic acid resin with IEC=1.05 mmol/g is dissolved, the dissolved perfluorosulfonic acid resin is put into the water alcohol mixture, sulfonic acid resin solution with a concentration of 20 wt % is formed; and then perfluorosulfonic acid resin broken micro-particles with IEC =0.4 mmol/g, an average particle size of 20 pm and irregular polyhedron morphology are added to the sulfonic acid resin solution and are homogenized in a ball mill, and a dispersion liquid with a content of 5 wt % is formed.

Through spraying, the dispersion liquid is adhered to surfaces at two sides of the above ion exchange membrane surface, and a discontinuous multi-porous gas release layer with a porosity of 35% is formed after drying, wherein: a distribution quantity of the perfluorosulfonic acid resin broken micro-particles on the composite membrane surface is 15 mg/cm², a hydrophilicity of the membrane is tested by a contact angle measuring instrument, and a contact angle is 83°.

An electrolytic test of the prepared ion exchange membrane about NaCl aqueous solution in an electrolysis cell described in Example 1 is performed; a current density is 10 KA/m²; after 13 days of electrolysis experiments, an average cell voltage is 2.83 V, and an average current efficiency is 99.0%.

Afterwards, based on standard SJ/T 10171.5, a surface resistance of the obtained membrane is tested to be 1.2 Ω·cm⁻²; based on ASTM Standard D 1044-99, a wear loss of the obtained membrane is tested to be 3.8 mg.

1. A zero polar distance ion exchange membrane, wherein:
the zero polar distance ion exchange membrane is a polymer membrane compositely prepared by perfluorinated ion exchange resin and a reinforcement material; the polymer membrane is converted to an ion exchange membrane, a non-electrode multi-porous gas release layer is attached to at least one side of the ion exchange membrane; the non-electrode multi-porous gas release layer is formed by drying after adhering a dispersion liquid to an ion exchange membrane surface; the dispersion liquid is formed by dispersing perfluorosulfonic acid resin broken micro-particles in a sulfonic acid resin water alcohol solution.

2. The zero polar distance ion exchange membrane, as recited in claim 1, wherein: the perfluorosulfonic acid resin broken micro-particles are formed by converting perfluorosulfonic acid resin in NaOH solution to sodium-type, and then grinding through a nano grinding machine, and finally obtaining the broken micro-particles with irregular polyhedron morphology.

3. The zero polar distance ion exchange membrane, as recited in claim 1, wherein: the reinforcement material is one of a mesh material, a fibrous material, a nonwoven fabric material and a porous membrane material which are made of any one of polytetrafluoroethylene (PTFE), polyperfluoroalkoxy resin (PFA), poly ethylene propylene (FEP), and ethylene-tetrafluoroethylene copolymer (ETFE).

4. The zero polar distance ion exchange membrane, as recited in claim 1, wherein: a surface hydrophilic contact angle of the ion exchange membrane attached with the non-electrode multi-porous gas release layer is smaller than 90°, and a surface resistance of the ion exchange membrane is lower than 1.2 Ω·cm⁻².

5. The zero polar distance ion exchange membrane, as recited in claim 1, wherein: an ion exchange capability of the perfluorosulfonic acid resin broken micro-particles is in a range of 0.4-0.9 mmol/g; and a particle size of the perfluorosulfonic acid resin broken micro-particles is in a range of 0.05-20 μm.

6. The zero polar distance ion exchange membrane, as recited in claim 5, wherein: in the dispersion liquid, a content of the perfluorosulfonic acid resin broken micro-particles by weight is 5-40%.

7. The zero polar distance ion exchange membrane, as recited in claim 1, wherein: in the sulfonic acid resin water alcohol solution, a content of the sulfonic acid resin by weight is 0.05-20%.

8. The zero polar distance ion exchange membrane, as recited in claim 5, wherein: a distribution quantity of the perfluorosulfonic acid resin broken micro-particles on the polymer membrane surface is 0.01-15 mg/cm².

9. The zero polar distance ion exchange membrane, as recited in claim 4, wherein: the non-electrode multi-porous gas release layer is a non-continuous multi-porous layer, and has a porosity of 35-99%.

10. A preparation method of a zero polar distance ion exchange membrane, comprising steps of:
(1) through a screw extruder, in a co-extrusion manner, melting and casting perfluorinated ion exchange resin to a single layer membrane or a multi-layer composite membrane, and simultaneously, introducing a reinforcement material between two membrane forming rollers, pressing the reinforcement material into a membrane body under an action of a pressure between the rollers, and forming a polymer membrane;
(2) immersing the polymer membrane in the step (1) to a mixed aqueous solution of dimethyl sulfoxide and NaOH, and converting the polymer membrane into an ion exchange membrane with ion exchange function;
(3) dissolving perfluorosulfonic acid resin, putting the dissolved perfluorosulfonic acid resin into a water alcohol mixture, forming sulfonic acid resin water alcohol solution, adding perfluorosulfonic acid resin broken micro-particles, homogenizing in a ball mill, and forming a dispersion liquid; and
(4) through surface coating, adhering the dispersion liquid to the ion exchange membrane surface obtained in the step (2), forming a discontinuous multi-porous gas release layer after drying, and obtaining a product.
